(19) United States
(12) Patent Application Publication
(10) Pub. No.: US 2024/0159931 A1
(43) Pub. Date: May 16, 2024

(54) DEVICES, SYSTEMS, AND METHODS FOR GEOLOGICAL SURFACE AND PROPERTY PREDICTION

(71) Applicant: Schlumberger Technology Corporation, Sugar Land, TX (US)

(72) Inventors: Nestor Herman Cuevas, Tananger (NO); Hilde Grude Borgos, Tananger (NO); Geir Vaaland Dahl, Tananger (NO); Michael Hermann Nickel, Tananger (NO)

(21) Appl. No.: 18/422,228

(22) Filed: Jan. 25, 2024

Related U.S. Application Data
(63) Continuation of application No. 18/485,339, filed on Oct. 12, 2023.
(60) Provisional application No. 63/382,913, filed on Nov. 9, 2022.

(51) Int. Cl. G01V 1/30; E21B 49/08; G01V 11/00

(52) U.S. Cl. CPC G01V 1/301; E21B 49/087; G01V 1/306; G01V 11/005; G01V 2210/66

(57) ABSTRACT

A system and method that include receiving seismic survey data, the seismic survey data including a seismic geological property. The system and method also include receiving resistivity sensor data from a downhole resistivity sensor, the resistivity sensor data being for a reference length uphole of a reference depth. The system and method additionally include determining a sensed geological property of a geological feature in the reference length, the sensed geological property being determined based on the resistivity sensor data. The system and method also include determining a covariance of the sensed geological property and the seismic geological property and applying an uncertainty model to the sensed geological property and the covariance of the sensed geological property, the uncertainty model generating an output including an uncertainty distribution of a projected geological property downhole of the reference depth.

### CROSS-REFERENCE TO RELATED APPLICATIONS

This application is a continuation of and claims priority to, U.S. application Ser. No. 18/485,339 filed 12 Oct. 2023, which claims priority to and the benefit of a US Provisional Application having Ser. No. 63/382,913, filed 9 Nov. 2022, both of which are incorporated by reference herein in their entirety.

### BACKGROUND OF THE DISCLOSURE

Many natural resources are accessible located underground. Such natural resources include water reservoirs and hydrocarbon reservoirs such as natural gas and oil. To access these natural resources, downhole drilling systems may drill a wellbore along a trajectory to a target location, formation, or geological feature. To assist in the planning of the trajectory of the wellbore, a drilling system may prepare simulations and projections of geological features.

### SUMMARY

According to one aspect, a method may include receiving seismic survey data, the seismic survey data including a seismic geological property. The method may also include receiving resistivity sensor data from a downhole resistivity sensor, the resistivity sensor data being for a reference length uphole of a reference depth. The method may additionally include determining a sensed geological property of a geological feature in the reference length, the sensed geological property being determined based on the resistivity sensor data. The method may also include determining a covariance of the sensed geological property and the seismic geological property. The method may further include applying an uncertainty model to the sensed geological property and the covariance of the sensed geological property, the uncertainty model generating an output including an uncertainty distribution of a projected geological property downhole of the reference depth.

According to another aspect, a system may include a processor and memory, the memory including instructions which, when accessed by the processor. The instructions also include receiving seismic survey data, the seismic survey data including a seismic geological property. The instructions may additionally include receiving resistivity sensor data from a downhole resistivity sensor, the resistivity sensor data being for a reference length uphole of a reference depth. The also instructions may also include determining a sensed geological property of a geological feature in the reference length, the sensed geological property being determined based on the resistivity sensor data. The instructions may additionally include determining a covariance of the sensed geological property and the seismic geological property. The instructions may further include applying an uncertainty model to the sensed geological property and the covariance of the sensed geological property, the uncertainty model generating an output including an uncertainty distribution of a projected geological property downhole of the reference depth.

According to yet another aspect, a non-transitory computer-readable medium storing instructions that, when executed by one or more processors of a computing system, cause the computing system to perform a method for interpreting drilling dynamics data. The method may include receiving seismic survey data, the seismic survey data including a seismic geological property. The method may additionally include receiving resistivity sensor data from a downhole resistivity sensor, the resistivity sensor data being for a reference length uphole of a reference depth. The method may also include determining a sensed geological property of a geological feature in the reference length, the sensed geological property being determined based on the resistivity sensor data. The method may additionally include determining a covariance of the sensed geological property and the seismic geological property. The method may further include applying an uncertainty model to the sensed geological property and the covariance of the sensed geological property, the uncertainty model generating an output including an uncertainty distribution of a projected geological property downhole of the reference depth.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure may be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a representation of a drilling system for drilling an earth formation to form a wellbore, according to at least one embodiment of the present disclosure;

FIG. 2-1 and FIG. 2-2 are representations of a wellbore plot, according to at least one embodiment of the present disclosure;

FIG. 3 is a representation of a geological projection system that generates projected surfaces of a geological feature, according to at least one embodiment of the present disclosure;

FIG. 4 is a flowchart of a method for generating a projected surface of a geological feature, according to at least one embodiment of the present disclosure;

FIG. 5 is a flowchart of a method for generating a projected geological property of a geological feature, according to at least one embodiment of the present disclosure; and

FIG. 6 is a representation of a computing system, according to at least one embodiment of the present disclosure.

### DETAILED DESCRIPTION

This disclosure generally relates to devices, systems, and methods for preparing an uncertainty distribution of a projected geological feature. A multivariate stochastic model is used on seismic data and resistivity data. The seismic data is generated before drilling the wellbore. The seismic data may be used to generate a seismic surface of the geological feature. The resistivity data is collected downhole using a resistivity sensor located on a bottom hole assembly (BHA). The resistivity data may be used to generate a sensed surface of the geological feature that is more representative of the actual location of the geological feature. A displacement field correcting the seismic surface may be generated using the difference between the seismic surface and the sensed surface. The displacement field may then be used to correct the seismic surface and more accurately predict a projected location of the geological feature downhole of the bit.

Conventionally, a projected surface is prepared using one or more deterministic steps. Such deterministic models generate the projected surface as a single surface. But the deterministic models do not account for uncertainty. This may result in a deterministically generated projected surface being presented with a greater level of confidence than may be warranted. For example, uncertainties in the measurements and/or projection models may result in the projected surface being located at a different location than the actual surface of the geological feature. In some situations, a deterministically generated projected surface may result in an operator preparing wellbore trajectories on incomplete or inaccurate information, or may instill a false sense of confidence in the operator regarding decisions made with respect to the deterministically generated projected surface. This may result in the wellbore being drilled off course, such as by intersecting the geological feature, entering/leaving a reservoir defined by the geological feature, or otherwise being directed off course.

In accordance with at least one embodiment of the present disclosure, an uncertainty model may prepare an uncertainty distribution for a projected surface of the geological feature. For example, the uncertainty model may incorporate uncertainty into the projected location of the geological feature. The uncertainty may originate from any source. For example, the uncertainty may originate from measurement uncertainty in the various measured parameters (e.g., resistivity data, seismic data, bit location, bit orientation). In some examples, the uncertainty may originate from interpretation of survey data. In some examples, the uncertainty may originate from the models used to generate a surface of the geological feature from the survey data. In some examples, the uncertainty may originate from the correction between the seismic surface and the sensed surface.

The uncertainty distribution may be based on a reference length uphole of the bit location. For example, the uncertainty model may include a correlation function. The correlation function may correlate the relationship between the survey data for the reference length uphole of the bit location. The correlation function may correlate the uncertainty in the projected surfaces based on the distance downhole from the bit, with a larger distance downhole from the bit increasing the uncertainty.

The uncertainty in the uncertainty model may be defined using a covariance matrix. The covariance matrix may provide a variance of the values away from a mean value. For example, a surface may have a distribution including, for a given location, a mean value and a covariance matrix of variances at a location. The covariance matrix may incorporate the uncertainty of the value. For example, the covariance matrix for the sensed surface may have uncertainty values based on the measurement uncertainty of the resistivity sensor. The uncertainty model may prepare a covariance matrix for the projected surface based on one or more of the covariance matrices of the sensed surface, the seismic surface, or the displacement field. In some embodiments, the covariance matrix for the projected surface may be based, at least in part, on the correlation function.

As illustrated by the foregoing discussion, the present disclosure utilizes a variety of terms to describe features and advantages of the geological projection system discussed herein. Additional detail is now provided regarding the meaning of such terms. For example, as used herein, the term “uncertainty” refers to the unknown variation in a value. In particular, the term uncertainty may be any unknown variation. For example, the variation may be a result of the accuracy and/or the precision of a particular sensor, the accuracy and/or the precision may be affected by the calibration of the sensor, bias introduced through the sensor, the environment surrounding the sensor, operator error, and so forth. The variation may be a result of calculations based on data. For example, the formulas may be based on assumptions that introduce uncertainty into the results. In some embodiments, uncertainty may be introduced based on the natural variability of the underlying geology.

As used herein, a “geological feature” may be any element of a geological formation. For instance, a geological feature may include a geological structure, such as a formation, strata, a fault, a reservoir, an uplift, a depression, an anticline, a syncline, a horst, a graben, a fold, any other geological structure, and combinations thereof. A geological feature may include the entire geological structure. A geological feature may include a volume of space, including one or more structures, rock types, material types, and so forth. In some embodiments, a geological feature may include a boundary between two geological structures, such as a boundary between strata. In some embodiments, a geological feature may include a boundary between rock types. In some embodiments, a geological feature may include a specific structure of a set of structures, such as a fluid reservoir. A geological feature may be three-dimensional. For example, a geological feature may include a three-dimensional surface having variation in latitude, longitude, and depth.

As used herein, a surface, such as a seismic surface, a projected surface, an observed surface, a determined surface, an uncertainty field of a surface, or other surface, may include any geological feature. In some embodiments, the surface may include a single geological feature. In some embodiments, the surface may include multiple geological features. In some embodiments, the surface may include a volume of space in the formation or rock.

As used herein, a “projection” or a “projected” element may be an element that has predicted or proposed values. A projection may be based on relationships between similar elements, such as relationships between resistivity sensor data and seismic sensor data. Any element may be projected. For example, a drilling system may include a projection of a geological feature, a projection of a geologic property, a projection of uncertainty, any other projection, and combinations thereof.

As used herein, “uphole” of the bit or other feature of the drilling system refers to a location that is closer to the collar of the wellbore. Uphole may not refer to a direction that is located above the portion of the drilling system (e.g., above with respect to the force of gravity), but refers to a direction that is closer to the collar in the direction of drilling.

As used herein, “downhole” of the bit or other feature of the drilling system refers to a location that is further away from the collar of the wellbore. Uphole may not refer to a direction that is located below the portion of the drilling system (e.g., below with respect to the force of gravity), but refers to a direction that is further away from the collar in the direction of drilling. When the bit is at the bottom of the wellbore, “downhole” of the bit may project into the formation in the direction of the target path or trajectory of the wellbore.

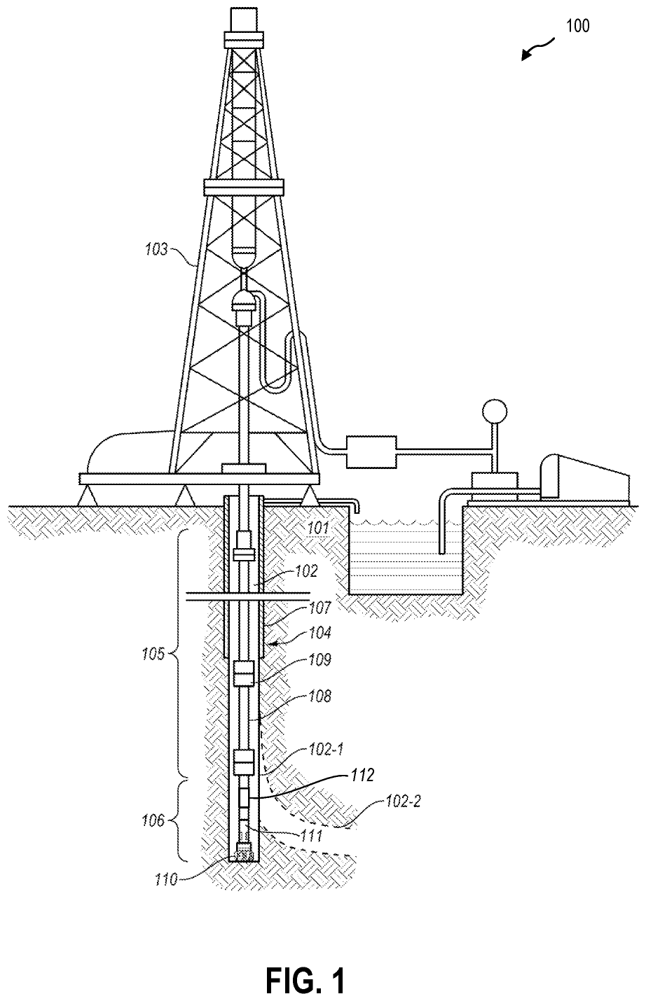

By way of background, FIG. 1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (BHA) 106, and a bit 110, attached to the downhole end of the drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through nozzles, jets, or other orifices in the bit 110 for the purposes of cooling the bit 110 and cutting structures thereon, for lifting cuttings out of the wellbore 102 as it is being drilled, for controlling influx of fluids in the well, for maintaining the wellbore integrity, and for other purposes.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (MWD) tools, logging-while-drilling (LWD) tools, downhole motors, underreamers, section mills, hydraulic disconnects, jars, vibration or damping tools, other components, or combinations of the foregoing. The BHA 106 may further include a directional tool 111 such as a bent housing motor or a rotary steerable system (RSS). The directional tool 111 may include directional drilling tools that change a direction of the bit 110, and thereby the trajectory of the wellbore 102. In some cases, at least a portion of the directional tool 111 may maintain a geostationary position relative to an absolute reference frame, such as gravity, magnetic north, or true north. Using measurements obtained with the geostationary position, the directional tool 111 may locate the bit 110, change the course of the bit 110, and direct the directional tool 111 on a projected trajectory. For instance, although the BHA 106 is shown as drilling a vertical portion 102-1 of the wellbore 102, the BHA 106 (including the directional tool 111) may instead drill directional or deviated well portions, such as directional portion 102-2.

In general, the drilling system 100 may include additional or other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

In some embodiments, the BHA 106 may include a downhole motor to power for downhole systems and/or provide rotational energy for downhole components (e.g., rotate the bit 110, drive the directional tool 111, etc.). The downhole motor may be any type of downhole motor, including a positive displacement pump (such as a progressive cavity motor) or a turbine. In some embodiments, a downhole motor may be powered by the drilling fluid flowing through the drill pipe 108. In other words, the drilling fluid pumped downhole from the surface may provide the energy to rotate a rotor in the downhole motor. The downhole motor may operate with an optimal pressure differential or pressure differential range. The optimal pressure differential may be the pressure differential at which the downhole motor may not stall, burn out, overspin, or otherwise be damaged. In some cases, the downhole motor may rotate the bit 110 such that the drill string 105 may not be rotated at the surface, or may rotate at a different rate (e.g., slower) than the rotation of the bit 110.

The bit 110 in the BHA 106 may be any type of bit suitable for degrading downhole materials such as the earth formation 101. Example types of drill bits used for drilling earth formations are fixed-cutter or drag bits, roller cone bits, and combinations thereof. In other embodiments, the bit 110 may be a mill used for removing metal, composite, elastomer, other downhole materials, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to surface or may be allowed to fall downhole. In still other embodiments, the bit 110 may include a reamer. For instance, an underreamer may be used in connection with a drill bit and the drill bit may bore into the formation while the underreamer enlarges the size of the bore.

While performing drilling activities, a geological projection system may prepare projections of various geological features of the earth formation 101. These projections may be located around geological features of interest, such as formations to be drilled through, reservoir boundaries, and so forth. A drilling operator may prepare a target trajectory or a target path of the wellbore 102. For example, the drilling operator may prepare a projected directional portion 102-2 of the wellbore 102. The drilling operator may prepare the projected directional portion 102-2 based on the projected geological feature. For example, the operator may prepare the projected directional portion 102-2 to avoid crossing the projected geological feature.

The geological projection system may receive information regarding the earth formation 101 based on one or more sets of survey data. For example, the geological projection system may receive seismic survey data from a seismic survey. The seismic survey may be conducted from the surface of the drilling system 100 and may include seismic data for a large amount of the earth formation 101, including the target path of the wellbore 102. Using the seismic data, the geological projection system may identify one or more seismic surfaces of a geological feature.

But accurate location of the geological feature using seismic data may be difficult, based on the measurement uncertainty of the seismic survey instrument, the distance of the geological feature from the seismic survey instrument, the type of formation being analyzed, any other feature of the seismic survey, and combinations thereof. The BHA 106 may include one or more resistivity sensors 112. The resistivity sensor 112 may collect resistivity sensor data from the earth formation 101 uphole of the bit 110. Resistivity sensor data may be collected by transmitting an electromagnetic field through the earth formation 101. The variation in the electromagnetic field through the earth formation 101 may be the resistivity of the earth formation 101.

Resistivity sensor data may be used to determine geological properties of the earth formation 101. For example, the resistivity sensor data may be used to determine one or more geological surfaces or structures. In some situations, the sensed surface of the geological features determined using the resistivity sensor data may be more accurate or representative of the actual geological feature of the earth formation 101 than the seismic surface. This may be because the one or more resistivity sensors 112 is located downhole, and therefore closer to the relevant geological structures of the earth formation 101 than the seismic survey instrument.

In accordance with at least one embodiment of the present disclosure, the seismic surface may be “corrected” based on the sensed surface. For example, as will be discussed in further detail herein, the geological projection system may generate a displacement field of the difference between the sensed surface and the seismic surface. The displacement field may include one or more of a bulk shift and a displacement between the sensed surface and the seismic surface. In some embodiments, the correction, including the bulk shift and the displacement field, may be applied to a volume of space of the formation. For example, features, formations, and so forth in the entire volume of space may be corrected between the seismic survey data and the resistivity survey data.

The geological projection system may use the displacement field behind (e.g., uphole of) the bit 110 to prepare a projected surface of the geological feature ahead (e.g., downhole) of the bit 110. For example, the displacement field and the seismic survey data ahead of the bit 110 may be used to correct the seismic surface generated based on the seismic survey data alone.

As discussed herein, the geological projection system may incorporate or include uncertainty in the projected surface. As used in this example (and in other examples herein), uncertainty may be a representation of a range of variability in a parameter or a property. Uncertainty may be a range of variability in the values of a parameter, including a range of variability in actual values, a range of variability in measured values, a range of variability in projected values, a range of variability in accuracy of values, a range of variability in precision of values, any other range of variability in the values of a parameter, and combinations thereof.

In accordance with at least one embodiment of the present disclosure, the geological projection system may apply an uncertainty model to one or more of the seismic survey data, the resistivity survey data, or the displacement field. An uncertainty model may be a model that identifies and/or quantifies uncertainty in a parameter. For example, an uncertainty model may provide a range of values representative of the uncertainty in the value of a particular parameter. The uncertainty model may identify and/or quantify uncertainty in a measured parameter, a calculated parameter, a projected parameter, and so forth. The uncertainty model may provide the uncertainty in any manner, including confidence intervals, values within a certain range of uncertainty, or any other manner. In some embodiments, the uncertainty model may be a multivariate stochastic model. A multivariate stochastic model may include probability distributions having relationships between multiple variables. The multivariate stochastic model may incorporate random variations within the variables of the model. In this manner, the uncertainty model may generate a projected surface that incorporates uncertainty of the variables in the projected surface of the geological feature.

In some embodiments, the uncertainty may be based on spatial correlations between the variables, the reference distance from the bit 110, and the projected distance away from the bit 110. This may generate a wedge-shaped uncertainty distribution of the projected surface. Put another way, the further away from the location of the bit 110, the more uncertainty is present in the location of the projected surface.

The projected surface including the uncertainty distribution may allow the drilling operator to make more informed decisions regarding drilling parameters, including the trajectory of the wellbore. For example, if the drilling operator desires to avoid a particular geological feature, then he or she may use the uncertainty distribution to adjust at least one drilling parameter, including the trajectory of the wellbore based on an informed risk tolerance. In this manner, the drilling operator may more reliably avoid (or engage, depending on the situation) the geological feature. This may help to improve wellbore quality, reduce wear and tear on drilling equipment, improve rate of penetration, improve wellbore production, provide any other benefit, and combinations thereof.

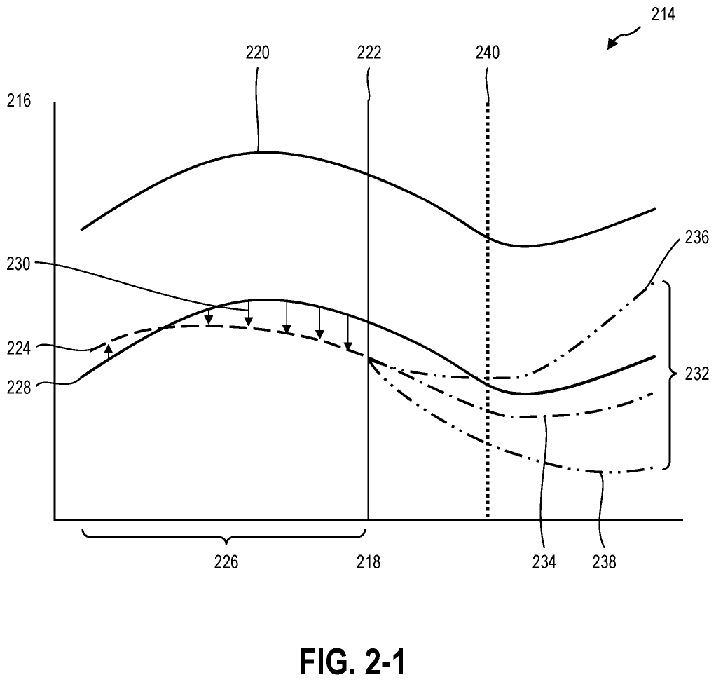

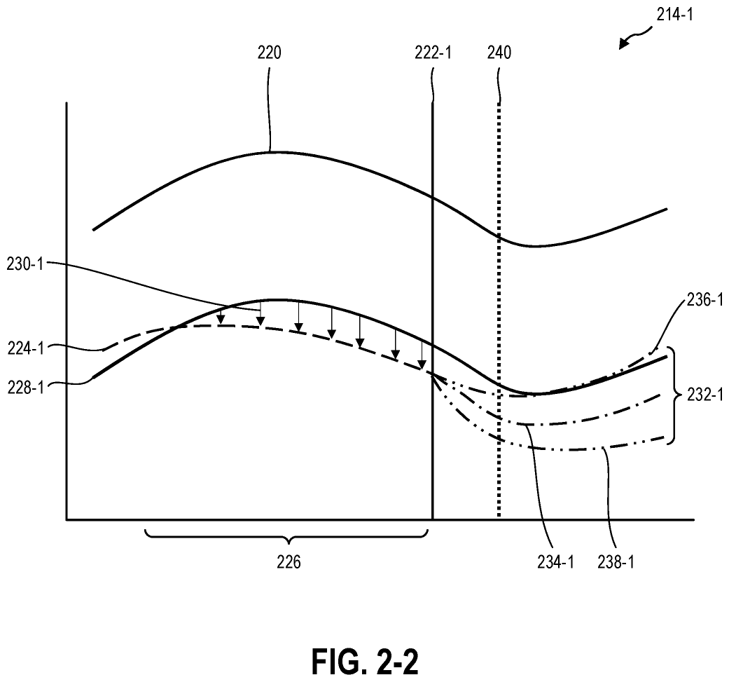

FIG. 2-1 is a schematic view of a wellbore plot 214 having elevation 216 on the y-axis (e.g., the vertical axis) and longitudinal location 218 on the x-axis (e.g., the horizontal axis), according to at least one embodiment of the present disclosure. The wellbore plot 214 includes a seismic surface 220 of a geological feature of interest. As discussed herein, the seismic surface 220 may be generated using seismic survey data. The wellbore plot 214 includes a reference depth 222. The reference depth 222 may be any location along a wellbore trajectory. For example, the reference depth 222 may be a distance from the collar. In some examples, the reference depth 222 may be the location of the bit. In some examples, the reference depth 222 may be the location of the bottom of the wellbore (e.g., the furthest extent of the wellbore). For ease of illustration, the longitudinal location 218 is shown as on a single axis. But it should be understood that the longitudinal location 218 may include two dimensions (e.g., a latitude and a longitude).

The wellbore plot 214 further includes a sensed surface 224. The sensed surface 224 may be generated from resistivity survey data. In some embodiments, the sensed surface 224 may be an observed surface or based on observed information. As discussed herein, the sensed surface 224 may be more accurate or representative of the actual geological feature of interest. The sensed surface 224 may be prepared uphole of the reference depth 222. In some embodiments, the sensed surface 224 may be generated continuously or in real-time, based on measurements from the resistivity sensor.

Using the sensed surface 224, a geological prediction system may prepare a modification or a correction to the seismic surface 220. Because the sensed surface 224 may be more representative of the actual surface of the geological feature than the seismic surface 220, the seismic surface 220 may be corrected to the sensed surface 224. This correction may then be used to prepare a projection of the geological feature uphole of the bit (e.g., to the right of the reference depth 222). In this manner, the projection may be more representative of the actual location of the geological feature.

The correction to the seismic surface 220 may be applied in one or more steps. For example, the seismic surface 220 may first receive a bulk shift to a bulk-shifted seismic surface 228. The bulk shift may be a general adjustment to the elevation 216 of the seismic surface 220. In some embodiments, the sensed surface 224 may have the same shape as the seismic surface 220. This may result in each longitudinal location 218 of the sensed surface 224 having the same difference in elevation 216 with the seismic surface 220. In this manner, the bulk shift may be the distance between the seismic surface 220 and the sensed surface 224. This may result in the bulk-shifted seismic surface 228 being located on or overlapping the sensed surface 224. Because the difference in elevation 216 between the seismic surface 220 and the sensed surface 224 is the same, the bulk shift to the bulk-shifted seismic surface 228 may be the only correction that may be applied to the seismic surface 220.

In some embodiments, such as the embodiment shown in FIG. 2-1, the sensed surface 224 may have a different shape than the seismic surface 220. In some embodiments, the bulk shift may be based on the average difference in elevation 216 between the seismic surface 220 and the sensed surface 224. This may result in a bulk-shifted seismic surface 228 that does not completely overlap the sensed surface 224. In some embodiments, the average difference in the elevation 216 between the seismic surface 220 and the sensed surface 224 may be calculated across an entirety of the length for which resistivity survey data to generate the sensed surface 224 is available. In some embodiments, the average difference in the elevation 216 between the seismic surface 220 and the sensed surface 224 may be calculated across the reference length 226. Calculating the average bulk shift for the reference length 226 may help to make the bulk shift more representative of the conditions close to the reference depth 222.

In the embodiment shown, the sensed surface 224 has a different shape or profile than the seismic surface 220. After the bulk shift is applied to the seismic surface 220 and the bulk-shifted seismic surface 228 generated, the geological projection system may generate a displacement field 230 of the difference between the bulk-shifted seismic surface 228 and the sensed surface 224. The displacement field 230 may be a representation of the difference between the bulk-shifted seismic surface 228 and the sensed surface 224 at each longitudinal location 218 of the wellbore plot 214. As may be seen, the displacement field 230 may incorporate an elevation 216 of the bulk-shifted seismic surface 228 that is higher or lower than the sensed surface 224. In some embodiments, the displacement field 230 may be calculated across an entirety of the longitudinal location 218 for which resistivity survey data is available. In some embodiments, the displacement field 230 may be calculated across the reference length 226.

While the displacement field 230 shown includes differences between the bulk-shifted seismic surface 228 and the sensed surface 224, in some embodiments, the displacement field 230 may be a representation of the differences between the seismic surface 220 and the sensed surface 224. In some embodiments, the displacement field 230 may include a heat map or other representation of the differences between any sensed geological features (e.g., any geological feature determined using the resistivity sensor data) and the seismically determined geological features (e.g., any geological feature determined using the seismic survey data). In this manner, the displacement field 230 may be three-dimensional and prepared for a large section of elevations 216.

The correction of the seismic surface 220 to a determined surface (e.g., the correction of the seismic surface 220 to match the sensed surface 224) may be described according to Eq. 1:

G=S+(B+D) Eq. 1

where G is the determined surface, S is the seismic surface 220, B is the bulk shift, and D is the displacement field. As discussed herein, the uncertainty model may be a multivariate stochastic model. In some embodiments, certain elements of the uncertainty model may be modeled using a Gaussian distribution. Thus, S may be estimated as:

S˜N(μ_{S},Σ_{S}) Eq. 2

where N is an indication of a Gaussian distribution, μₛ is the mean seismic value at a particular location, and Σₛ is the uncertainty of the seismic values. The uncertainty in the seismic values may be determined in any manner. For example, the seismic uncertainty may be determined based on the seismic sensor measurement uncertainty. In some examples, the seismic uncertainty may be determined empirically based on seismic extrema in the vicinity.

The bulk shift may be described as:

B˜N(μ_{B},σ_{B}²) Eq. 3

where μ_{B} is the mean bulk shift and σ²_{B} is the standard deviation of the bulk shift calculations. The bulk shift uncertainty may be estimated manually based on the distance of the bulk shift and/or the mechanism used to determine the bulk shift.

D may be estimated as:

D˜N(μ_{D},Σ_{D} Eq. 4

where μ_{D} is the mean displacement at a particular location and Σ_{D} is the uncertainty of the displacement field. As discussed herein, Σₛ and Σ_{D} may be covariance matrices including a covariance of the respective mean at each location. The displacement field uncertainty may be determined empirically based on the variability in the displacement field when the displacement field is generated.

Using the Gaussian distributions of S, B, and D, Eq. 1 may be re-written as:

G=S+(B+D)˜N(μ_{G},Σ_{G}) Eq. 5

where μ_{G} is the mean determined surface value and Σ_{G} is the uncertainty of the determined surface. As may be seen, the sum of B and D may be approximately equal to the Gaussian distribution of G.

While embodiments of the present disclosure may discuss Gaussian distributions of one or more of G, S, B, D, and other data sets, it should be understood that any distribution of data may be used for these data sets.

Eq. 5 may be used to project G in front of (e.g., to the right of) the reference depth 222. Indeed, by including the uncertainty of S, B, and D, the uncertainty of G may be determined. This may help to generate an uncertainty distribution of the projected surface. As may be seen in FIG. 2-1, the geological projection system may generate a projected surface uncertainty distribution 232. The projected surface uncertainty distribution 232 may include an average projected surface 234, an upper projected surface 236, and a lower projected surface 238.

The projected surface uncertainty distribution 232 may be a representation of the uncertainty present in the calculation of Eq. 5. As discussed herein, the uncertainty may be based on any source of uncertainty, such as measurement uncertainty and/or calculation uncertainty. More specifically, the uncertainty may be based on the uncertainty determined in S (e.g., Σ_{S}), B (e.g., σ²_{B}), and D (e.g., Σ_{D}). By calculating the projected surface using at least the uncertainties of S, B, and D, the projected surface uncertainty distribution 232 may provide an operator with a range of possible projected surfaces. This may help the operator to make drilling decisions (such as trajectory decisions) based on the projected surface uncertainty distribution 232. For example, if an operator desires to stay away from the geological feature, the operator may adjust the trajectory of the wellbore to stay above the upper projected surface 236 or below the lower projected surface 238.

The projected surface ahead of (e.g., to the right of) the reference depth 222 may be conditional based on the available options behind (e.g., to the left of) the reference depth 222. This may result in μ_{G} and Σ_{G} at a projected position xₚ being based on or conditioned on the projected surface at an observed position xₒ and the displacement field at xₒ. This may be expressed as:

μ_{G}(xₚ)|G(xₒ),D(xₒ) Eq. 6

Σ_{G}(xₚ)|G(xₒ),D(xₒ) Eq. 7

Thus, as may be seen, the mean and uncertainty of the projected surface may be based on or conditional to the observations behind the reference depth 222.

The expected surface (μ_{GP}) ahead of the reference depth 222 may further be calculated as:

μ_{GP}|Gₒ,Dₒ=μ_{GP}+f(Σᵢⱼ)[Dₒ−μ_{Do}]+g(Σᵢⱼ)[Gₒ−μ_{Go]} Eq. 8

where Σᵢⱼ is the cross covariance of Gₒ and Dₒ, μ_{Do} is the mean observed displacement and μ_{Go} is the mean observed determined surface (e.g., the sensed surface 224 in FIG. 2-1). The covariance of the projected surface (Σ_{GP}) may further be calculated as:

Σ_{GP}|Gₒ,Dₒ=Σ_{GP}−f(Σᵢⱼ)Σ_{DoGp}−g(Σᵢⱼ)Σ_{GoGp} Eq. 9

where Σ_{DoGo} is the covariance of the observed displacement and observed determined surface, Σ_{DoGo} is the covariance of the observed displacement and the predicted determined surface, and Σ_{GoGp} is the covariance of the observed determined surface and the predicted determined surface. In this manner, the uncertainty of the projected surface (e.g., the projected surface uncertainty distribution 232) may be based on the uncertainty of the observed measurements.

The cross covariance Σᵢⱼ may be expressed as:

Σᵢⱼ=σᵢσⱼρ(|xᵢ−xⱼ|) Eq. 10

where xᵢ and xⱼ are the lateral positions of the traces i and j of a covariance matrix and σᵢ and σⱼ are the standard deviations of xᵢ and xⱼ, respectively. The correlation function between the reference depth 222 and a point a distance ahead of the reference depth 222 may be expressed as p. In this manner, the uncertainty of the projected surface may be based on the reference length 226 and the distance ahead of the reference depth 222. As may be seen in FIG. 2-1, this may be expressed in a projected surface uncertainty distribution 232 that has an average projected surface 234 with an upper projected surface 236 and a lower projected surface 238 that extend further away from the average projected surface 234 in elevation 216 based on an increased distance from the reference depth 222.

The correlation function ρ may be used to generate the projected surface uncertainty distribution 232. In some embodiments, the correlation function ρ may prepare a correlation value. The correlation value may be based on the distance away from reference depth 222 (e.g., the distance in front of the reference depth 222). The correlation value may be 1 at the reference depth 222. The correlation value may be less than 1 at a distance in front of the reference depth 222. The length of the reference length 226 may determine the minimum correlation among all the included observed points and the prediction points. The geological projection system may generate the projected surface uncertainty distribution 232 at a particular projection point 240. The correlation function ρ may generate a correlation value based on the distance of the particular projection point 240 from the reference depth 222. As the projection point 240 moves further away from the reference depth 222, the correlation value generated by the correlation function ρ may decrease. In this manner, the correlation function ρ may, at least in part, determine the spread of the projected surface uncertainty distribution 232, or the distance from the average projected surface 234 to the upper projected surface 236 and the lower projected surface 238. In this manner, the projected surface may include uncertainty that is based on both the uncertainty of the observed measurements and/or calculations and the distance of the projection point 240 away from the reference depth 222. This may help the drilling operator to make informed trajectory decisions based on the projected surface uncertainty distribution 232.

In some embodiments, when the projection point 240 is moved far ahead of 222, the correlation approaches approximately 0. At that distance, the spread of the upper projected surface 236 and the lower projected surface 238 may be determined by the original seismic surface uncertainty and the estimated bulk shift. This may result in no further increasing spread between the upper projected surface 236 and the lower projected surface 238 due to correlation. For example, the upper projected surface 236 and the lower projected surface 238 may become parallel to 234 if seismic surface uncertainty is constant.

The correlation function ρ may be any type of function that returns a value in the interval of [−1, 1]. For example, the correlation function may be an exponential function, a Gaussian function, a damped cosine function, a sine-squared function, a polynomial function, a hyperbolic function, a linear function, any other type of function, and combinations thereof.

In accordance with at least one embodiment of the present disclosure, the surfaces discussed herein may be three-dimensional surfaces. For example, the seismic surface 220 and the sensed surface 224 may be three-dimensional surfaces that extend into and out of the page. In this manner, the observed surfaces may incorporate representations of the three-dimensional nature of geological features. In some examples, the projected surface uncertainty distribution 232 may be a three-dimensional uncertainty distribution. For example, the average projected surface 234, the upper projected surface 236, and the lower projected surface 238 may be three-dimensional, and extend into and out of the page. In this manner, the projected surfaces may be representative of the three-dimensional nature of geological surfaces. This may allow the drilling operator to make adjustments to at least one drilling parameter. For example, the drilling operator may adjust the trajectory of the drilling tool in elevation 216 and/or azimuth.

While embodiments of the present disclosure have discussed geological features with respect to the geological property of elevation, it should be noted that any geological property may be projected using the techniques discussed herein. For example, any geological property may be estimated or inferred using the available data, such as rock type, acoustic properties, chemical properties, porosity, fluid transport, any other property, and combinations thereof. The displacement field 230 may be a displacement field between a seismically determined geologic property and a resistivity-sensor determined geologic property.

In accordance with at least one embodiment of the present disclosure, the geological projection system may update the wellbore plot 214 based on additional received survey data. For example, the reference depth 222 may be a depth of the bit or a lowest depth of resistivity survey data. As the wellbore advances (e.g., as the bit drills further and/or as the resistivity sensor collects resistivity survey data further downhole), the reference depth may be updated to a new reference depth 222-1, as illustrated in the new wellbore plot 214-1 of FIG. 2-2.

In the new wellbore plot 214-1, the seismic surface 220 may be the same seismic surface 220 shown in FIG. 2-1. This may be because the seismic survey data may remain constant or the same between the reference depth 222 and the new reference depth 222-1. Using the new resistivity data, the geologic projection system may generate a new sensed surface 224-1. The new sensed surface 224-1 may be generated for the reference length 226. As may be seen, the reference length 226 in the new wellbore plot 214-1 may extend the same length uphole of the new reference depth 222-1. This may change the reference portion of the wellbore downhole based on the position of the new reference depth 222-1. In this manner, the correlation function ρ may help to project the projected surfaces based on the data within the reference length 226 uphole of the new reference depth 222-1, making the projected surfaces correlated to the most recent survey data.

In some embodiments, the bulk shift from the seismic surface 220 to the new sensed surface 224-1 may be a new bulk shift. This may result in a new bulk-shifted seismic surface 228-1. A new displacement field 230-1 may be generated based on the new sensed surface 224-1 and the new bulk-shifted seismic surface 228-1.

The geologic projection system may apply the uncertainty model to one or more of the seismic surface 220, the new sensed surface 224-1, the new bulk-shifted seismic surface 228-1, and the new displacement field 230-1. The uncertainty model may generate a new projected surface uncertainty distribution 232-1 having a new average projected surface 234-1, a new upper projected surface 236-1, and a new lower projected surface 238-1.

As may be seen, the new projected surface uncertainty distribution 232-1 may be narrower at the same projection point 240. This may be because the projection point 240 is located closer to the new reference depth 222-1. Because the projection point 240 is located closer to the new reference depth 222-1, the correlation function ρ may indicate that the correlation between the projection point 240 and the data sets in the reference length 226 from the new reference depth 222-1 is greater than the correlation between the projection point 240 and the data sets in the reference length 226 from the reference depth 222.

In accordance with at least one embodiment of the present disclosure, the wellbore plot 214 may be updated during drilling operations. For example, during drilling operations, geological projection system may receive new resistivity survey data at a new reference point. The geological projection system may generate new surface projections using the new resistivity data. In this manner, the wellbore plot 214 may be updated based on new resistivity survey data.

The resistivity survey data may be transmitted to the surface using downhole transmission methods (e.g., electromagnetic transmission, wired drill pipe, mud pulse telemetry). In some embodiments, the resistivity survey data may be transmitted to the surface in real-time, or as the resistivity survey data is measured. In some embodiments, the wellbore plot 214 may be updated as soon as new resistivity survey data is received. In this manner, the wellbore plot 214 may be updated in real-time based on real-time transmission of the resistivity survey data. In some embodiments, because downhole transmission methods may be in the range of bits or kilobits per second, the resistivity survey data may be transmitted to the surface periodically. In this situation, the wellbore plot 214 may be updated periodically, as new resistivity survey data is received. Updating the wellbore plot 214 when new resistivity survey data is transmitted to the surface may allow the drilling operator to make adjustments to the wellbore trajectory based on the updated wellbore plot 214 generated in real-time or periodically. This may allow the drilling operator to direct the wellbore trajectory in response to the updated wellbore plot 214.

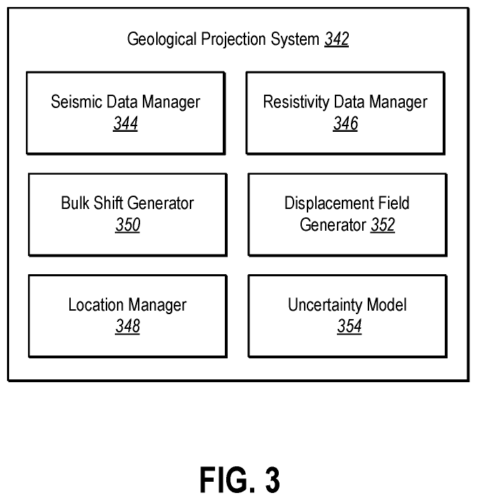

FIG. 3 is a representation of a geological projection system 342 that generates projected surfaces of a geological feature, according to at least one embodiment of the present disclosure. Each of the components 344-354 of the geological projection system 342 may include software, hardware, or both. For example, the components 344-354 may include one or more instructions stored on a computer-readable storage medium and executable by processors of one or more computing devices, such as a client device or server device. When executed by the one or more processors, the computer-executable instructions of the geological projection system 342 may cause the computing device(s) to perform the methods described herein. Alternatively, the components 344-354 may include hardware, such as a special-purpose processing device to perform a certain function or group of functions. Alternatively, the components 344-354 of the geological projection system 342 may include a combination of computer-executable instructions and hardware.

Furthermore, the components 344-354 of the geological projection system 342 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 344-354 may be implemented as a stand-alone application, such as a desktop or mobile application. Furthermore, the components 344-354 may be implemented as one or more web-based applications hosted on a remote server. The components 344-354 may also be implemented in a suite of mobile device applications or “apps.”

The geological projection system 342 includes a seismic data manager 344. The seismic data manager 344 may receive seismic survey data from a seismic survey instrument. The seismic data manager 344 may generate a seismic surface (e.g., the seismic surface 220 of FIG. 2-1) using the seismic survey data. In some embodiments, the seismic data manager 344 may determine the uncertainty associated with the seismic survey data. In some embodiments, the seismic data manager 344 may generate the covariance matrix of the seismic surface. For example, the seismic data manager 344 may generate the covariance matrix based on the empirical data within the seismic survey data, such as the values of extreme data points in the seismic survey data. In some embodiments, the seismic data manager 344 may generate the covariance matrix based on the seismic survey instrument, such as a known accuracy, precision, or other known factors of the seismic survey instrument. In some embodiments, the seismic data manager 344 may generate the covariance matrix based uncertainty from the process used to generate the seismic surface. In some embodiments, the seismic data manager 344 may generate the covariance matrix using any combination of processes discussed herein.

The geological projection system 342 includes a resistivity data manager 346. The resistivity data manager 346 may receive resistivity data from the resistivity sensor (e.g., the one or more resistivity sensor 112 of FIG. 1). The resistivity data manager 346 may generate a sensed surface (e.g., the sensed surface 224 of FIG. 2-1) or an observed surface of a geological feature based on the resistivity survey data. In some embodiments, as discussed herein, the resistivity data manager 346 may receive a reference depth (e.g., the reference depth 222 FIG. 2-1) and a reference length (e.g., the reference length 226 of FIG. 2-1) of a wellbore from a location manager 348. In some embodiments, the resistivity data manager 346 may generate the sensed surface over the reference length from the reference depth.

In some embodiments, the resistivity data manager 346 may determine the uncertainty associated with the resistivity survey data. For example, the resistivity data manager 346 may generate a covariance matrix for the resistivity survey data, such as a covariance matrix for the sensed surface. In some embodiments, the resistivity data manager 346 may generate the covariance matrix based on empirical data, such as through variation in the observed resistivity survey data. In some embodiments, the resistivity data manager 346 may generate the covariance matrix based on the resistivity sensor, such as a known accuracy, precision, or other known factors of the resistivity instrument. In some embodiments, the resistivity data manager 346 may generate the covariance matrix based uncertainty from the process used to generate the sensed surface. In some embodiments, the resistivity data manager 346 may generate the covariance matrix using any combination of processes discussed herein.

The geological projection system 342 includes a bulk shift generator 350. The bulk shift generator 350 may determine the bulk shift from the seismic surface to the sensed surface. For example, as discussed herein, the bulk shift generator 350 may determine the bulk shift based on an average distance from the seismic surface to the sensed surface. In some embodiments, in the stochastic model, the mean and variance of the bulk shift is given by equations similar to Eq. 8 and 9. If a bulk shift is already applied (e.g., based on shifting the seismic after landing the well), the estimate from the stochastic model is considered a correction to the applied bulk shift. In some embodiments, the bulk shift generator 350 may generate a bulk-shifted seismic surface (e.g., the bulk-shifted seismic surface 228 of FIG. 2-1). The bulk shift generator 350 may determine the uncertainty associated with the bulk shift. For example, the bulk shift generator 350 may generate a variance measure for the bulk shift. In some examples, the bulk shift generator 350 may generate the variance measure based on the uncertainties in the seismic survey data, the resistivity survey data, the process used to generate the bulk shift, and combinations thereof.

The geological projection system 342 includes a displacement field generator 352. The displacement field generator 352 may generate a displacement field based on the difference between the seismic surface and the sensed surface. In some embodiments, the displacement field generator 352 may generate the displacement field based on the difference between the bulk-shifted seismic surface and the sensed surface. In some embodiments, the displacement field generator 352 may determine the uncertainty of the displacement field. For example, the displacement field generator 352 may generate a covariance matrix of the displacement field. In some examples, the displacement field generator 352 may generate the covariance matrix based on the uncertainties in the seismic survey data, the resistivity survey data, the process used to generate the displacement field, and combinations thereof.

The geological projection system 342 includes a location manager 348. The location manager 348 may determine the extent of the generated surfaces. For example, the location manager 348 may determine the reference depth. In some embodiments, the location manager 348 may determine the reference depth based on the deepest resistivity sensor data. In some embodiments, the location manager 348 may determine the reference depth based on the depth of the bit. In some embodiments, the location manager 348 may determine the reference depth based on the depth of any downhole tool. In some embodiments, the location manager 348 may determine the reference depth based on a projected directional portion of a wellbore.

The location manager 348 may determine the reference length. In some embodiments, the location manager 348 may determine the reference length based on any factor. For example, the location manager 348 may determine the reference length based on the amount of available resistivity sensor data. In some examples, the location manager 348 may determine the reference length based on sensed downhole features. In some examples, the location manager 348 may determine the reference length based on the uncertainty in one or more of the seismic surface, the resistivity surface, the bulk shift, the displacement field, and combinations thereof. In some examples, the location manager 348 may determine the reference length based on a received input from an operator.

The geological projection system 342 includes an uncertainty model 354. The uncertainty model 354 may generate a projected surface based on one or more model inputs. The model inputs may include the seismic survey data, the resistivity survey data, the bulk shift, the displacement field, the reference depth, the reference length, any other input, and combinations thereof.

In some embodiments, the uncertainty model 354 may generate uncertainties for the projected surfaces. For example, the uncertainty model 354 may generate an uncertainty distribution of a projected surface of a geological feature. The uncertainty distribution of the projected surface may be based on the uncertainties of the model inputs. In some embodiments, the uncertainty distribution of the projected surface may be based on a correlation between the model inputs over the reference length uphole of the reference depth and a projection point downhole of the reference depth. In some embodiments, the uncertainty model 354 may be trained to generate the projected surfaces. For example, the uncertainty model 354 may be trained to generate the uncertainty distribution of the projected surface.

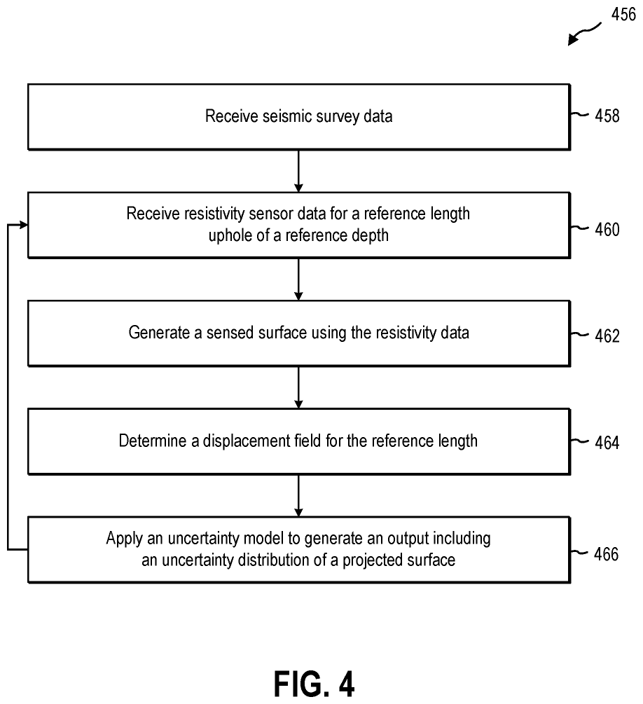

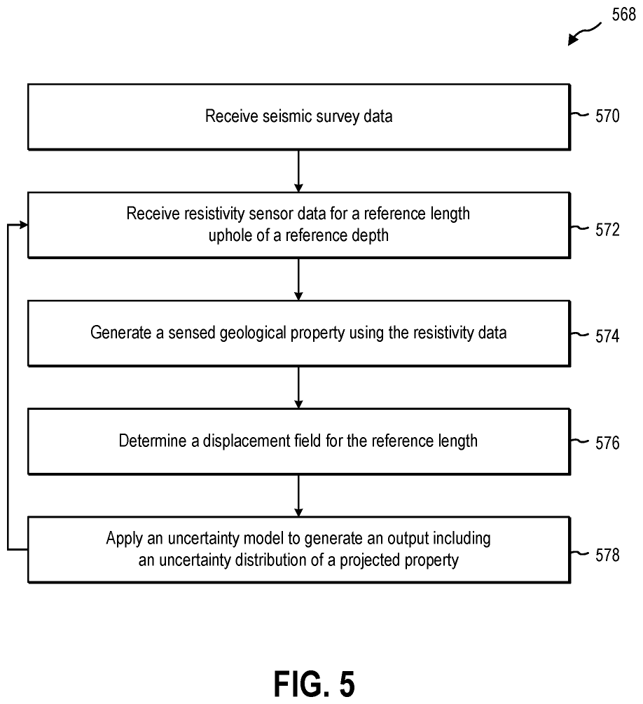

FIGS. 4-5, the corresponding text, and the examples provide a number of different methods, systems, devices, and non-transitory computer-readable media of the geological projection system 342. In addition to the foregoing, one or more embodiments may also be described in terms of flowcharts comprising acts for accomplishing a particular result, as shown in FIGS. 4-5. FIGS. 4-5 may be performed with more or fewer acts. Further, the acts may be performed in differing orders. Additionally, the acts described herein may be repeated or performed in parallel with one another or parallel with different instances of the same or similar acts.

As mentioned, FIG. 4 illustrates a flowchart of a series of acts of a method 456 for generating a projected surface of a geological feature, according to at least one embodiment of the present disclosure. While FIG. 4 illustrates acts according to one embodiment, alternative embodiments may omit, add to, reorder, and/or modify any of the acts shown in FIG. 4. The acts of FIG. 4 may be performed as part of a method. Alternatively, a non-transitory computer-readable medium may comprise instructions that, when executed by one or more processors, cause a computing device to perform the acts of FIG. 4. In some embodiments, a system may perform the acts of FIG. 4.

The geological projection system may receive seismic survey data at 458. In some embodiments, the seismic survey data may include a seismic surface. In some embodiments, the geological projection system may generate the seismic surface using the seismic survey data. The geological projection system may receive resistivity sensor data from a downhole resistivity sensor at 460. The geological projection system may receive the resistivity sensor data from the downhole resistivity sensor in any transmission mechanism such as wireless transmission, wired drill pipe transmission, mud pulse telemetry, and so forth. The geological projection system may receive the resistivity sensor for a reference length uphole of a reference depth of the wellbore. In some embodiments, the downhole resistivity sensor may transmit resistivity sensor data that extends beyond the reference depth of the wellbore. Using the resistivity data, the geological projection system may generate a sensed surface over the reference length at 462.

The geological projection system may generate a displacement field of a difference between the sensed surface and the seismic surface at 464. In some embodiments, the geological projection system may generate the displacement field for the reference length. In some embodiments, the geological projection system may generate the displacement field for more than the reference length.

The geological projection system may apply an uncertainty model to at least one of the resistivity sensor data, the seismic survey data, or the displacement field at 466. The uncertainty model may generate an output that includes an uncertainty distribution of a projected surface of the geological feature downhole of the reference depth. In some embodiments, the uncertainty model may generate the uncertainty distribution using the uncertainty of the data from the reference length. In some embodiments, the uncertainty model may generate the uncertainty distribution using a correlation function that correlates the data from the reference length with the distance downhole of the reference depth.

In some embodiments, the geological projection system may generate projected surfaces in real time. For example, the geological projection system may receive second resistivity sensor data for the reference length based on a second reference depth. The geological projection system may generate a second sensed surface and correct the seismic surface based on the second sensed surface. In some embodiments, the geological projection system may generate a second bulk shift and a second displacement field based on the second sensed surface. In some embodiments, the geological projection system may apply the uncertainty model to one or more of the second sensed surface, the second bulk shift, the second displacement field, and the seismic surface. The second application of the uncertainty model may include a second application of the correlation function based on the reference length and the second reference depth. This process may be repeated for each set of resistivity sensor measurements received by the geological projection system.

As mentioned, FIG. 5 illustrates a flowchart of a series of acts of a method 568 for generating a projected geological property of a geological feature, according to at least one embodiment of the present disclosure. While FIG. 5 illustrates acts according to one embodiment, alternative embodiments may omit, add to, reorder, and/or modify any of the acts shown in FIG. 5. The acts of FIG. 5 may be performed as part of a method. Alternatively, a non-transitory computer-readable medium may comprise instructions that, when executed by one or more processors, cause a computing device to perform the acts of FIG. 5. In some embodiments, a system may perform the acts of FIG. 5.

The geological projection system may receive seismic survey data at 570. In some embodiments, the seismic survey data may include a seismic geological property. The seismic geological property may be a geological property that is determined or inferred using the seismic survey data. In some embodiments, the geological projection system may generate the seismic geological property using the seismic survey data. In some embodiments, the seismic geological property may be included as part of the seismic survey data. The geological projection system may receive resistivity sensor data from a downhole resistivity sensor at 572. The geological projection system may receive the resistivity sensor data from the downhole resistivity sensor in any transmission mechanism such as wireless transmission, wired drill pipe transmission, mud pulse telemetry, and so forth. The geological projection system may receive the resistivity sensor for a reference length uphole of a reference depth of the wellbore. In some embodiments, the downhole resistivity sensor may transmit resistivity sensor data that extends beyond the reference depth of the wellbore. Using the resistivity data, the geological projection system may generate a sensed geological property over the reference length at 574. The sensed geological property may be the same geological property as the seismic geological property.

The geological projection system may generate a displacement field of a difference between the sensed geological property and the seismic geological property at 576. The displacement field may have the same units or basis as the sensed geological property and the seismic geological property. In some embodiments, the geological projection system may generate the displacement field for the reference length. In some embodiments, the geological projection system may generate the displacement field for more than the reference length.

The geological projection system may apply an uncertainty model to at least one of the resistivity sensor data, the sensed geological property, the seismic survey data, the seismic geological property, or the displacement field at 578. The uncertainty model may generate an output that includes an uncertainty distribution of a projected geological property of the geological feature downhole of the reference depth. In some embodiments, the uncertainty model may generate the uncertainty distribution of the projected geological property using the uncertainty of the data from the reference length. In some embodiments, the uncertainty model may generate the uncertainty distribution of the projected geological property using a correlation function that correlates the data from the reference length uphole of the reference depth with the distance downhole of the reference depth. In this manner, the projected geological property may be based on the sensed geological property and the seismic geological property based on the data in the reference length uphole of the reference depth. This may make the projected geological property more representative of the actual geological property being modeled. This may allow the drilling operator to make drilling decisions based on the projected geological property and the associated uncertainty distribution of the projected geological property.

In some embodiments, the geological projection system may generate projected geological features in real time. For example, the geological projection system may receive second resistivity sensor data for the reference length based on a second reference depth. The geological projection system may generate a second sensed geological feature and correct the seismic surface based on the second sensed geological feature. In some embodiments, the geological projection system may generate a second bulk shift and a second displacement field based on the second sensed geological feature. In some embodiments, the geological projection system may apply the uncertainty model to one or more of the second sensed geological feature, the second bulk shift, the second displacement field, and the seismic geological feature. The second application of the uncertainty model may include a second application of the correlation function based on the reference length and the second reference depth. This process may be repeated for each set of resistivity sensor measurements received by the geological projection system.

The embodiments of the geological projection system have been primarily described with reference to wellbore drilling operations. However, it is to be appreciated that the geological projection system described herein may be used in applications other than the drilling of a wellbore. In other embodiments, geological projection systems according to the present disclosure may be used outside a wellbore or other downhole environment used for the exploration or production of natural resources. For instance, geological projection systems of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

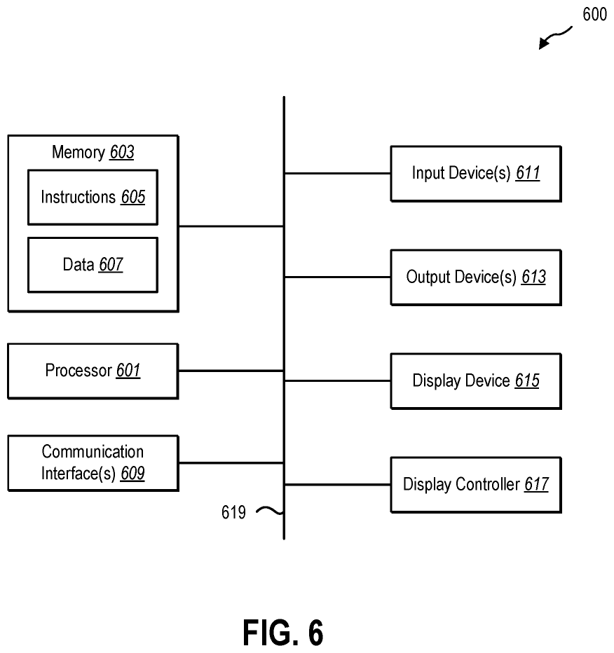

FIG. 6 illustrates certain components that may be included within a computing system 600. One or more computing systems 600 may be used to implement the various devices, components, and systems described herein.

The computing system 600 includes a processor 601. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computing system 600 of FIG. 6, in an alternative configuration, a combination of processors (e.g., an ARM and DSP) could be used.

The computing system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computing system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computing system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computing system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computing system 600 may be coupled together by one or more buses, which may include a power bus, a control signal bus, a status signal bus, a data bus, etc. For the sake of clarity, the various buses are illustrated in FIG. 6 as a bus system 619.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving seismic survey data, the seismic survey data including a seismic geological property;
receiving resistivity sensor data from a downhole resistivity sensor, the resistivity sensor data being for a reference length uphole of a reference depth;
determining a sensed geological property of a geological feature in the reference length, the sensed geological property being determined based on the resistivity sensor data;
determining a covariance of the sensed geological property and the seismic geological property; and
applying an uncertainty model to the sensed geological property and the covariance of the sensed geological property, the uncertainty model generating an output including an uncertainty distribution of a projected geological property downhole of the reference depth.

2. The method of claim 1, further comprising adjusting at least one drilling parameter based on a projected surface of the geological feature downhole of the reference depth and the uncertainty distribution.

3. The method of claim 1, wherein determining the sensed geological property of a geological feature includes determining a displacement field of a difference between the sensed geological property and the seismic geological property, wherein the displacement field is generated for the reference length.

4. The method of claim 3, wherein determining the displacement field includes determining a bulk shift and a displacement of a seismic surface to a sensed surface.

5. The method of claim 1, wherein determining the covariance is based on measurement uncertainty of the resistivity sensor data.

6. The method of claim 1, wherein an uncertainty of the uncertainty model is defined using a covariance matrix that provides a variance of values away from a mean value.

7. The method of claim 1, wherein determining the covariance is based on a measurement uncertainty of the seismic survey data.

8. The method of claim 1, wherein determining the covariance is based on a measurement uncertainty of an interpolation between reference offset wellbores.

9. The method of claim 1, wherein the uncertainty distribution outputted from the uncertainty model is based at least in part on the covariance for the reference length, wherein the uncertainty distribution includes a three-dimensional surface ahead of the reference depth.

10. A system, comprising:
a processor and memory, the memory including instructions which, when accessed by the processor, cause the processor to:
receive seismic survey data, the seismic survey data including a seismic geological property;
receive resistivity sensor data from a downhole resistivity sensor, the resistivity sensor data being for a reference length uphole of a reference depth;
determine a sensed geological property of a geological feature in the reference length, the sensed geological property being determined based on the resistivity sensor data;
determine a covariance of the sensed geological property and the seismic geological property; and
apply an uncertainty model to the sensed geological property and the covariance of the sensed geological property, the uncertainty model generating an output including an uncertainty distribution of a projected geological property downhole of the reference depth.

11. The system of claim 10, wherein the instructions also cause the processor to adjust at least one drilling parameter based on a projected surface of the geological feature downhole of the reference depth and the uncertainty distribution.

12. The system of claim 10, wherein determining the sensed geological property of a geological feature includes determining a displacement field of a difference between the sensed geological property and the seismic geological property, wherein the displacement field is generated for the reference length.

13. The system of claim 12, wherein determining the displacement field includes determining a bulk shift and a displacement of a seismic surface to a sensed surface.

14. The system of claim 10, wherein determining the covariance is based on measurement uncertainty of the resistivity sensor data.

15. The system of claim 10, wherein an uncertainty of the uncertainty model is defined using a covariance matrix that provides a variance of values away from a mean value.

16. The system of claim 10, wherein determining the covariance is based on a measurement uncertainty of the seismic survey data.

17. The system of claim 10, wherein determining the covariance is based on a measurement uncertainty of an interpolation between reference offset wellbores.

18. The system of claim 10, wherein the uncertainty distribution outputted from the uncertainty model is based at least in part on the covariance for the reference length, wherein the uncertainty distribution includes a three-dimensional surface ahead of the reference depth.

19. A non-transitory computer-readable medium storing instructions that, when executed by one or more processors of a computing system, cause the computing system to perform a method for interpreting drilling dynamics data, the method comprising:
receiving seismic survey data, the seismic survey data including a seismic geological property;
receiving resistivity sensor data from a downhole resistivity sensor, the resistivity sensor data being for a reference length uphole of a reference depth;
determining a sensed geological property of a geological feature in the reference length, the sensed geological property being determined based on the resistivity sensor data;
determining a covariance of the sensed geological property and the seismic geological property; and
applying an uncertainty model to the sensed geological property and the covariance of the sensed geological property, the uncertainty model generating an output including an uncertainty distribution of a projected geological property downhole of the reference depth.

20. The non-transitory computer-readable medium of claim 19, wherein the uncertainty distribution outputted from the uncertainty model is based at least in part on the covariance for the reference length, wherein the uncertainty distribution includes a three-dimensional surface ahead of the reference depth.
